(19) United States
(12) Patent Application Publication
(10) Pub. No.: US 2006/0039098 A1
(43) Pub. Date: Feb. 23, 2006

(54) Multi-panel display device

(75) Inventors: Peter J Slikkerveer, Eindhoven (NL); Petrus Cornellis Paulus Bouten, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronis N.C.

(21) Appl. No.: 10/529,960

(22) PCT Filed: Sep. 12, 2003
(86) PCT No.: PCT/IB03/03953

§ 371 Date: Mar. 31, 2005

(30) Foreign Application Priority Data
Oct. 4, 2002 (EP) 02079132.3

(51) Int. Cl. H01G 9/00

(52) U.S. Cl. 361/500

(57) ABSTRACT

A back plane or carrier (5), mechanically coupled to display panels (2) is bendable or foldable. Preferably it is zigzag foldable in one direction, the pitch of zigzag in the unfolded position being substantially equal to the dimension of the corresponding display panel in said direction. This leads to very efficient packaging of the display device in the second (folded) position, especially when the back plane is also zigzag foldable in the second direction.

The invention relates to a display device comprising an assembly of at least two display panels, each display panel having a first surface and a second surface at least parts of the first surfaces in a first position forming a display surface. Such displays are used generally at areas where large display panels are required, e.g. in railway stations, airports, etceteras. The present innovation is related to such display devices comprising an assembly of at least two display panels (multi-panel displays), especially but not exclusively to using such displays in handheld, mobile applications.

The invention furthermore relates to a flexible carrier for such a display.

U.S. Pat. No. 5,673,091 describes a display device in which a two dimensional matrix of display panels constitute a large area display device. By assembling these display panels in the manner of roof tiles a constant pitch is obtained between picture elements of neighbouring display panels.

The display device however has a fixed construction, which is not very attractive for mobile applications like telephones, PDA's and laptops. In such mobile applications like it would be a great advantage to be able to store the display device in (very) small packages for easy transport (e.g. in a pocket).

A first solution would be a display device that can be rolled up when stored and unrolled when used. Rolling up display devices, however, has its limitations. Only one of the directions of the display can be reduced; the axial direction of the roll will be unchanged. Moreover the roll will have a finite radius, limited by the flexibility, integrity and thickness of the display device. This gives a lower limit to the thickness of the roll. Rolling up to a very small radius will require very thin display devices, which will become very sensitive to indentation etc.

A second solution viz. to fold the display device itself in a two-dimensional way also has its limitations. Generally a display device cannot be folded onto itself, without loosing its (local) performance. The localized very high strains make it more likely that such display devices will consist of display panels with non-functional (elastic) hinges in between ergo it will behave like a tiled display (including the artifacts of the nonfunctional seams).

The present invention has as its object to overcome one or more of the above mentioned drawbacks. To this end in a display device according to the invention the back surfaces is mechanically coupled to a flexible carrier.

Since a separate back plane is provided which may be of a material different from the display device material this back plane may be optimized for the required flexible applications. The material of the back plane may be foldable or bendable or rollable. On the other hand the separate display panels need not even be flexible.

Whenever in this Patent Application the wording “foldable”,“bendable” or “rollable” is used, this does not necessarily mean that the complete back plane is foldable, bendable or rollable. The back plane may be foldable at certain places only e.g. at the area of a border between two display panels.

In the second position two adjacent display panels may have either the first surfaces opposite to each other or the second surfaces opposite to each other. This does not exclude the possibility of a further display panel between said two adjacent display panels in the folded state.

In a further embodiment the back plane is zigzag foldable in at least one direction.

In this patent application the wording “pitch of a zigzag” is used which refers to the distance over which the pattern of folding repeats itself in the unfolded state. This implies that a zig and a zag (defined as the two separate parts of the folding between two folds at a distance of a pitch) next to each other together have the length of a pitch in the folding direction, although a zig and a zag next to each other in said direction not necessarily have the same dimension (length).

In a preferred embodiment the back plane is zigzag foldable in one direction the pitch of zigzag in the unfolded position being substantially equal to the dimension of the corresponding display panel in said direction. This leads to very efficient packaging of the display device in the second (folded) position, especially when the back plane is also zigzag foldable in the second direction the pitch of zigzag in the unfolded position being substantially equal to the dimension of the corresponding display panel in said second direction. In this respect it is noted that DE 19714301 shows a construction of different display panels which are obtained by zigzag folding the separate display parts; however no back plane is shown here, but mechanical interconnection is obtained via a zipper.

These and other aspects of the invention are apparent from and will be elucidated with reference to the embodiments described hereinafter.

In the drawings:

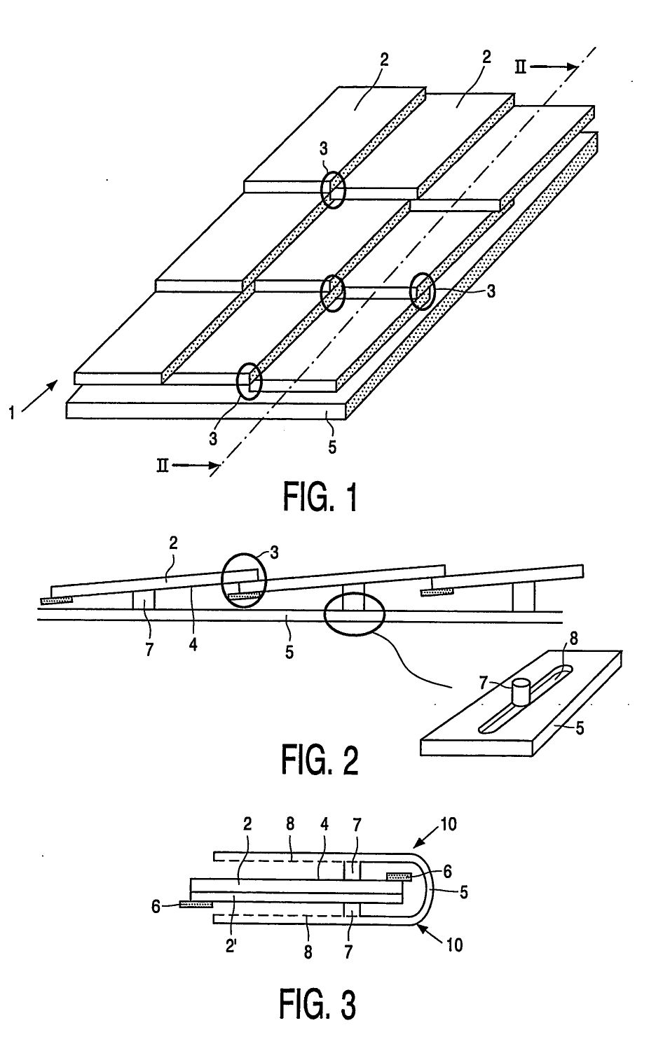

FIG. 1 shows diagrammatically a display device according to the invention,

FIG. 2 shows a cross-section along line 11-11 in FIG. 1,

FIGS. 3, 4, and 5 show cross-sections of the display device according to the invention during folding,

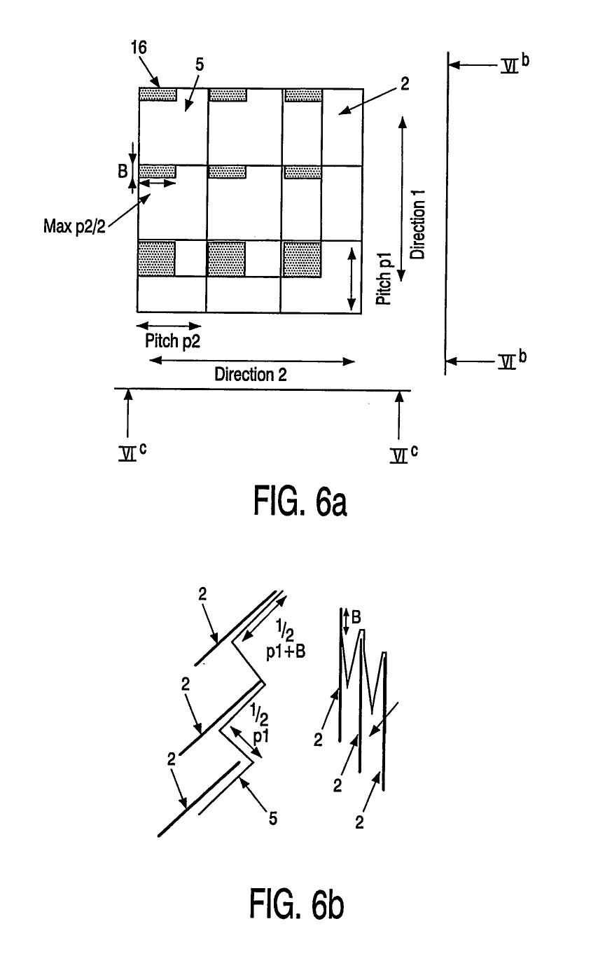

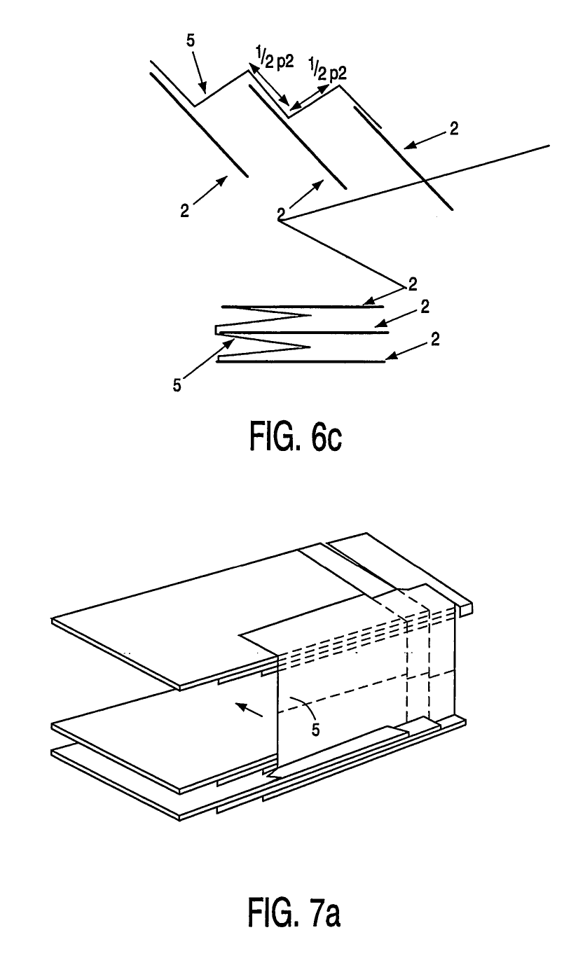

FIG. 6 diagrammatically shows a further display device according to the invention, together with the principle of zigzag folding while,

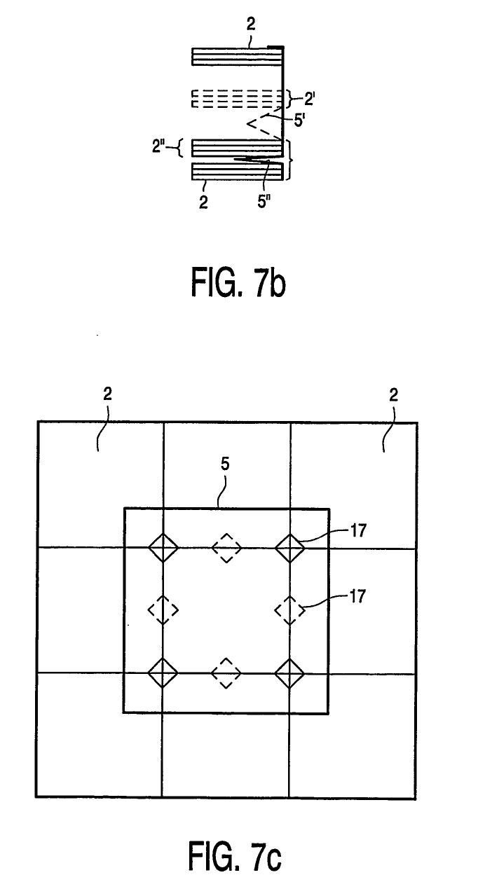

FIG. 7 diagrammatically shows a display device based on the principle of zigzag folding and

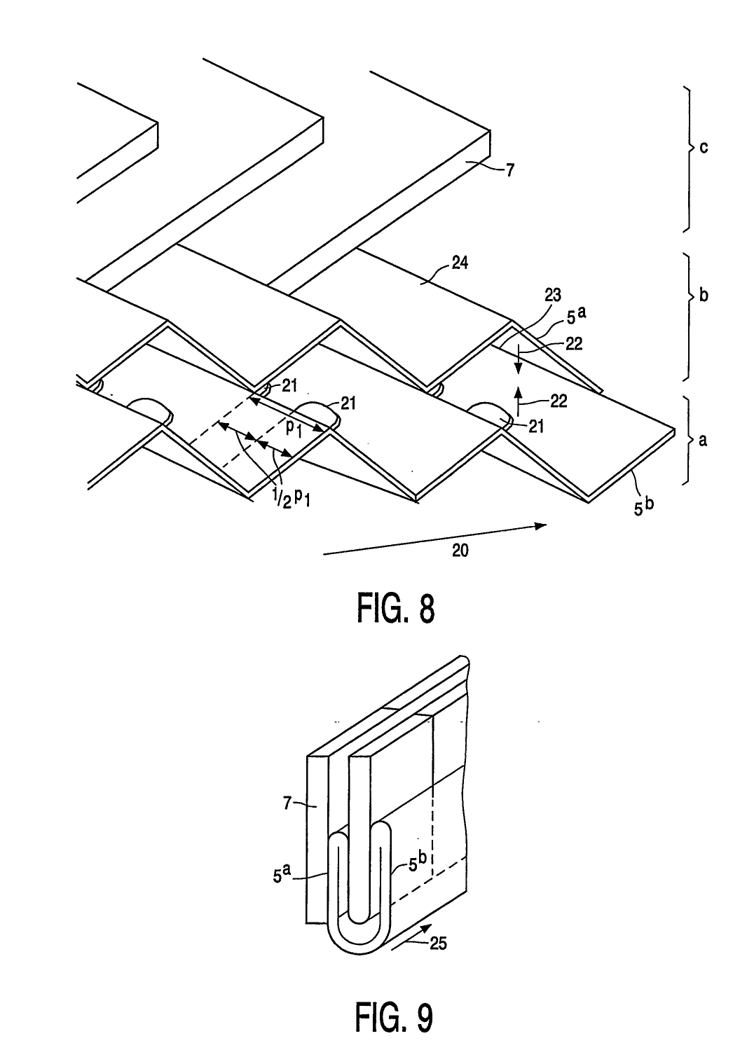

FIGS. 8 and 9 diagrammatically show a further display device based on the principle of zigzag folding

The Figures are diagrammatic and not drawn to scale. Corresponding elements are generally denoted by the same reference numerals.

The embodiment of FIG. 1 shows a way of tiling, where the display panels 2 of the display 1 overlap each other like roof tiles. The overlap of the panels 2 is adjusted in such way that the display areas are supplementary, viewed from the position of the viewer (the front of the display). At overlapping parts 3 the display area of a lower display panel can be viewed through the transparent rim of the top display panel that e.g. includes a transparent seal. The parallax caused by the top display effect and the bottom display effect is limited by the small thickness of the display (e.g. <300 micron). The usual electrical connections can be used, which will be situated below the display panel on top.

In a similar way as for roof tiles, the tiling process can be extended in two dimensions like shown in FIG. 1, while maintaining the advantage of electrical connections beneath a tiling display panel and the parts of the tiles supplementary to the display panel areas. Further advantage can be found in that, by using a transparent seal on the top display the bottom display will be visible at the overlap, so the seal lines between the displays will be not or hardly visible.

Furthermore parallax originating from two adjacent displays not being in the same geometrical plane is made low by choosing a low thickness of the top display. If necessary the display can be made thinner at the overlap to reduce the overlap thickness and the parallax (e.g. by post-processing the bottom of top display after separation).

Optical defects caused by the overlapping displays (e.g. increased absorption by the top display and the parallax) can be further reduced by additional measures (e.g. designing for a special viewer position to counteract the parallax, or increasing the local light from a backlight for a transmissive LCD, a lens structure for reflective LCD or extra emission in case for (O) LED displays to counteract the additional absorption of extra substrates.

Besides, when using rigid tiled displays, sticky layers may be used at the areas of overlap to remove unwanted additional reflections.

FIG. 2 shows in a cross-section along line II-II in FIG. 1 how in a first position (the display position) back surfaces 4 being of the display panels 2 are mechanically coupled to a flexible carrier 5 of the display device 1 via connecting members 7. As mentioned above electrical interconnections 6 are preferably located within overlapping parts 3. As shown in the inset of FIG. 2 the carrier 5 may be provide with slits 8 for fixing at the one hand the positions of the connecting members 7 and at the other hand allowing these connecting members to move during folding of the carrier 5. Although in FIG. 2 the slits do not penetrate the carrier 5, in another implementation they are open slits, while the connecting members, at sides away from the panels may have thickenings or tops to maintain the connecting members within the slits.

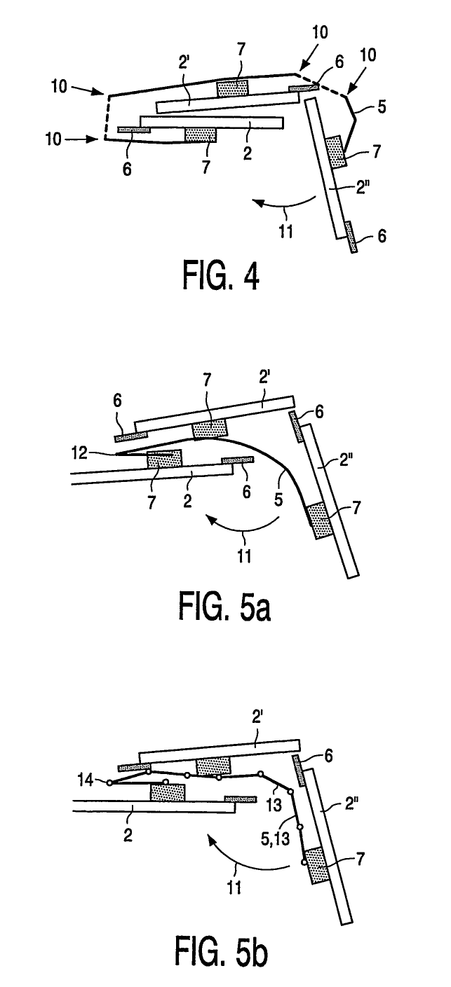

One possible way of folding or bending a carrier 5 comprising two panels 2 is shown in FIG. 3 in which the displaying sides of the panels have been folded (or bended) against each other. Although in this example the whole carrier 5 is flexible, it may be partly rigid and bendable (stretchable) only in a certain part (as shown in FIG. 4). During folding the connecting members 7 in this example have moved almost to the ends of slits 8.

FIG. 4 shows a possible way of folding (arrow 11) or bending a carrier 5 comprising three panels 2, 2′, 2″, two of which have their displaying sides of the panels folded (or bended) against each other. The carrier 5 is flexible may be partly rigid and bendable (stretchable) only in the part between arrows 10. The third panel 2″ in this example is folded with its displaying side towards the non-displaying side of panel 2′, but also the non-displaying sides of panels 2′, 2″ may be folded (or bended) against each other. From this example it will be clear that, especially during the process of folding, the connecting members 7 need not always be fixed to the carrier 5 (the connecting member 7 of panel 2′ can move freely with respect to the carrier 5).

FIG. 5 shows another possible way of folding (arrow 11) or bending a carrier 5 comprising three panels 2, 2′, 2″, two of which have now their non-displaying sides of the panels folded (or bended) against each other. The third panel 2″ may be folded with its displaying side towards either the non-displaying side or the displaying side of panel 2′ again. In the example of FIG. 5 (a) the carrier 5 is very flexible and has a sharp fold 12. In the example of FIG. 5 (b) the carrier 5 comprises non-flexible parts 13, which are mutually connected by hinges 15.

In FIG. 6 another way of folding viz. zigzag folding is described. For purposes of clarity only the display panels 2 (in this example a construction of 3×3 panels) and the carrier 5 is shown as well as a schematic indication of the areas 16 for electrical and or mechanical interconnections. It should be noted that in this particular example the area of the carrier 5 is smaller than the total display area.

Now, when folding, the flexible backplane or carrier 5 is folded in a zigzag manner, while the display sections (panels 2) slide over each other to their packed state. In this method a first direction of folding exists and a second direction of folding (which folding method is also applicable for folding displays tiled in one direction only).

In the first direction of folding (the vertical direction in FIG. 6^{a}) it may be necessary, for mechanical or electrical reasons to use “zigs” 15 and “zags” 15′ of different length as schematically shown in FIG. 6^{b}. On the other hand, to allow for connection in the second direction, it may be necessary to adapt the folding in the first direction by choosing the size of the “zig” (where the display is connected) larger than the “zag” to obtain a staggered method of piling up the display panels. For the connection to the display the length difference between the “zig” and the “zag” can be used (indicated as “B” in the FIG. 6^{b}).

For folding in the second direction (the horizontal direction in FIG. 6^{a}) the backplane is zigzag folded with a pitch of half the pitch p of the display panel tiling (see FIG. 6^{c}). The backplane can be mechanically connected over the full length of the “zig” 15 to the display section and over the pitch of the staggering (B) in the first direction (in case of a 2D display). The electrical contacts to the display sections can be realized on or near the mechanical contact between the display and the “zig” of the backplane.

By choosing the “zig” 15 and the “zag” 15′ of equal length, preferably ½ p, the display sections can be folded to a package of equal frontal surface of a single section (i.e. directly on top of each other, see right part of FIG. 6^{c}).

FIG. 7 shows such a display in a state where folding in said first direction has occurred having “zigs” and “zags” of different length in the already folded part (see FIG. 7^{a}), while the non-folded part has equal “zigs” and “zags”, as shown in the cross section of FIG. 7^{b}. In FIG. 7^{b} the reference numerals 5′ and 2′ refer to the carrier and (a stack of) displays in a partly folded state, whereas the reference numerals 5″ and 2″ refer to said carrier and (a stack of) displays in a folded state. As shown schematically in FIG. 7^{c} which shows a the back of carrier 5 folding may be made more easily by providing the carrier 5 with holes near edges or preferably corners of the display panels 2.

The folded display device in FIG. 7 has an area which is muchc larger than the area of a singl panel 7. This has been overcome in the example of FIG. 8, which shows a carrier 5 comprising sub-carriers 5^{a,b}. The lower side of FIG. 8 (indicated as a in FIG. 8) shows a part of this carrier viz. a sub-carrier 5^{b}. The sub-carrier 5^{b} is unfolded in this example but is also zigzag foldable in a second direction transverse to the first direction as indicated by arrow 20. The zigzags in both directions have a pitch p₁ in this example. The sub-carrier 5^{b} has connecting tabs 21 for connecting sub-carriers 5^{a,b} to each other at the folding areas of the zigzags the width of the connecting tab (and consequently the interconnection) at the folding area being restricted to at most half the pitch p₁.

The carrier 5 further has a sub-carrier 5^{a} (indicated as b in FIG. 8) on which the panels 7 have been fixed, the fixing area being restricted to half the pitch p₁. By stretching the carrier 5 in the direction 20 the sub-carriers 5a,b move towards each other (indicated by arrows 22) the back surface 23 of the first sub-carrier being coupled to the connecting tabs 21. The carrier 5 becomes flat and the display panels 7 (indicated as c in FIG. 8) are unfolded.

When folding the carrier as indicated by arrow 20 the sub-carriers move from each other each other contrary to the arrows 22 (although moving towards each other is not excluded. Panels in said direction (in a column), due to the zigzags shift over each other, while a folded zigzag of the sub-carriers 5^{a} remains between each set of neighboring panels in said direction (FIG. 9) and also a folded zigzag of the sub-carriers 5^{b} remains. The remaining structure is then folded in a direction transverse to de direction of arrow 20 (arrow 25 in FIG. 9). Since the width of the connecting tabs 21 at the folding areas of the zigzags (and consequently the interconnections of sub-carriers 5^{a,b} to each other) are restricted to at most half the pitch p₁ piles of panels (of a column), due to the zigzags shift over each other again, while a set of folded zigzag of the sub-carriers 5^{b} remains next to the pile of panels

The protective scope of the invention is not limited to the embodiments described, while the invention is also applicable to other display devices, for example electrophoretic or electrochromic displays. The display panels may even be realized in different technologies, e.g. (O)LED-technology for one or more display panels 2 and LCD technology for other display panels 2, e.g. for picture-in-picture applications.

On the other hand a smaller pitch zigzag may be used in the zigzag folding principle. The display panels are fixed at regular intervals to the “zigs” (e.g. every second or third “zig”) then.

In an alternative way of a display the flexible display panels are rolled up. Before rolling up the display the height (width) of the total display is reduced by folding via one of the methods discussed, after which the segments are rolled up together.

Furthermore to obtain a good display performance the overlapping parts of the displays should be as tightly to the bottom display as possible. This can be achieved by making each display panel slightly convex or the unfolded display a bit concave so the edges make contact or letting the display edges be attracted to the underlying display e.g. by magnetic strips. Also a click mechanism behind the display or in the mechanism that unfolds the display brings the edges of the display together. It also may be advantageous for folding a tiled display when not all panels have the same size.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements

1. A display device comprising an assembly of at least two display panels each display panel having a front surface and a back surface at least parts of the front surfaces in a first position forming a display surface the back surfaces being mechanically coupled to a flexible carrier.

2. A display device according to claim 1 the flexible carrier belonging to the group comprising foldable carriers, bendable carriers, rollable carriers, stretchable carriers, and extendable carriers.

3. A display device according to claim 1 the flexible carrier comprising sub-carriers being interconnected via joints.

4. A display device according to claim 1 at least one display panel being slidable with respect to the carrier.

5. A display device according to claim 1 in which in said first position adjacent panels have an overlap, the overlap comprising an interconnecting part for electrical interconnections.

6. A display device according to claim 5, the flexibility of the carrier accommodating two adjacent panels in an intermediate position to be separated apart over at least the overlap.

7. A display device according to claim 1 the flexible carrier being zigzag foldable

8. A display device according to claim 7 the flexible carrier being zigzag foldable in one direction the pitch of zigzag in the unfolded position being substantially equal to the dimension of the corresponding panel in said direction.

9. A display device according to claim 7 the flexible carrier being rollable or foldable in a second direction substantially transverse to the one direction.

10. A display device according to claim 9 the flexible carrier being zigzag foldable in the second direction the pitch of zigzag in the unfolded position being substantially equal to the dimension of the corresponding panel in said second direction.

11. A display device according to claim 7 the flexible carrier having a first sub-carrier carrying the display panels at a first front surface and a second sub-carrier, both sub-carriers being zigzag foldable and having the same pitch of the zigzag in a first direction, the sub-carriers being coupled to each other at the area of folding areas of the zigzags.

12. A display device according to claim 11 the second sub-carrier being zigzag foldable in a second direction substantially transverse to the first direction.

13. A display device according to claim 12 the second sub-carrier having connecting tabs at the folding areas of the zigzags.

14. A display device according to claim 13 the connecting tabs extending over at most half the pitch of a zigzag folding in a second direction transverse to the first direction.

15. A flexible carrier for a display device according to claim 7 having a first sub-carrier having a first front surface and a second sub-carrier, both sub-carriers being zigzag foldable and having the same pitch of the zigzag, the sub-carriers being coupled to each other at the area of folding areas of the zigzags.

16. A flexible carrier according to claim 15 the second sub-carrier being zigzag foldable in a second direction substantially transverse to the first direction.

17. A flexible carrier according to claim 15 the second sub-carrier having connecting tabs at the area of the folding areas of the zigzags

18. A flexible carrier according to claim 16 the connecting tabs extending over at most half the pitch of a zigzag folding in a second direction transverse to the first direction.
